(19) United States
(12) Patent Application Publication
(10) Pub. No.: US 2013/0003886 A1
(43) Pub. Date: Jan. 3, 2013

(54) METHOD FOR GENERATING AND DETECTING PREAMBLE, AND DIGITAL COMMUNICATION SYSTEM BASED ON THE SAME

(75) Inventors: Tae Wook Kang, Daejeon (KR); Hyung-Il Park, Daejeon (KR); In Gi Lim, Daejeon (KR); Sung Weon Kang, Daejeon (KR); Chang Hee Hyoung, Daejeon (KR); Jung Hwan Hwang, Daejeon (KR); Tae Young Kang, Seoul (KR); Kyung Soo Kim, Daejeon (KR); Jung Bum Kim, Daejeon (KR); Kyung Hwan Park, Daejeon (KR); Byoung Gun Choi, Daegu (KR); Sung Eun Kim, Seoul (KR)

(73) Assignee: Electonics and Telecommunications Research Institute, Daejeon (KR)

(21) Appl. No.: 13/539,108

(22) Filed: Jun. 29, 2012

(30) Foreign Application Priority Data
Jul. 1, 2011 (KR) 10-2011-0065672
Jun. 7, 2012 (KR) 10-2012-0060842

(51) Int. Cl. H04L 1/00; H04B 15/00; H04L 27/00

(52) U.S. Cl. 375/285; 375/296; 375/343; 375/341

(57) ABSTRACT

Provided is a method of generating and detecting a preamble that may significantly increase accuracy of frame synchronization while avoiding a low frequency domain having great noise power and minimizing hardware complexity and power consumption in a communication system of a digital direct transmission scheme applicable to human body communication. A method of generating a preamble according to an exemplary embodiment of the present disclosure includes: generating a first pseudo noise code and a second pseudo noise code that are different from each other; generating a plurality of same first sub preambles by line-coding the first pseudo noise code; and generating a second sub preamble behind the plurality of first sub preambles by line-coding the second pseudo noise code.

### CROSS-REFERENCE TO RELATED APPLICATIONS

This application is based on and claims priority from Korean Patent Application No. 10-2011-0065672, filed on Jul. 01, 2011, and Korean Patent Application No. 10-2012-0060842, filed on Jun. 07, 2012 with the Korean Intellectual Property Office, the disclosure of which is incorporated herein in its entirety by reference.

### TECHNICAL FIELD

The present disclosure relates to a method of generating and detecting a preamble in a communication system of a digital direct transmission scheme applicable to human body communication.

### BACKGROUND

Human body communication indicates a communication technology between apparatuses connected to a human body by utilizing the human body as a communication channel. A human body communication system generally employs a digital direct transmission scheme in order to simplify the structure and to minimize power consumption using a characteristic of a human body channel.

A human body channel has a high noise property in a frequency band of DC to 5 MHz. Accordingly, the human body communication system modulates data and thereby transmits and receives the modulated data in order to avoid the band of DC to 5 MHz in which a frequency band of data to be transmitted and be received has high noise due to a human body.

A communication apparatus used for the human body communication system includes a transmitter and a receiver, and mutual synchronization needs to be performed in order to transmit and receive a data frame between the transmitter and the receiver. For the above operation, the transmitter transmits a synchronization signal, that is, a preamble to inform start of the data frame. The receiver receives the preamble to thereby secure frame timing and then process the received data frame.

Accordingly, when the receiver does not accurately receive a preamble, the receiver may fail to receive a subsequently transmitted data frame or may receive erroneous data.

### SUMMARY

The present disclosure has been made in an effort to provide a method of generating and detecting a preamble that may significantly increase accuracy of frame synchronization while avoiding a low frequency domain having great noise power and minimizing hardware complexity and power consumption in a communication system of a digital direct transmission scheme applicable to human body communication.

An exemplary embodiment of the present disclosure provides a method of generating a preamble, including: generating a first pseudo noise code and a second pseudo noise code that are different from each other; generating a plurality of same first sub preambles by line-coding the first pseudo noise code; and generating a second sub preamble behind the plurality of first sub preambles by line-coding the second pseudo noise code.

A Manchester coding scheme or a Miller coding scheme may be employed for line-coding of the first pseudo noise code and the second pseudo noise code.

Another exemplary embodiment of the present disclosure provides a method of detecting a preamble including a plurality of same first sub preambles and a second sub preamble positioned behind the plurality of first sub preambles, the method including: iteratively detecting the first sub preamble by performing a correlation value calculation using a first pseudo noise code; detecting the second sub preamble by performing a correlation value calculation using a second pseudo noise code when the first sub preamble is detected at least a predetermined number of times; and determining that the preamble is received when the second sub preamble is detected. The first sub preamble and the second sub preamble may be generated by line-coding the first pseudo noise code and the second pseudo noise code, respectively.

The detecting of the first sub preamble may include: obtaining a correlation value of odd-numbered bit values and a correlation value of even-numbered bit values among received N bits, and calculating a difference value between the calculated two correlation values when the number of bits of the first sub preamble is N; and determining that the first sub preamble is detected when the difference value is greater than or equal to a first reference value. When the number of bits of the first sub preamble is N, and when the first sub preamble is detected at least twice and a distance between the respective detection positions is an integer multiple of N, the detecting of the second sub preamble may be initiated.

The detecting of the second sub preamble may include: obtaining a correlation value of odd-numbered bit values and a correlation value of even-numbered bit values among received M bits, and calculating a difference value between the calculated two correlation values when the number of bits of the second sub preamble is M; and determining that the second sub preamble is received when the difference value is greater than or equal to a second reference value.

The detecting of the second sub preamble may include: determining a position corresponding to a maximum correlation value using a maximum likelihood estimation; and determining that the second sub preamble is detected when a distance between the position corresponding to the maximum correlation value and a final detection position of the first sub preamble is an integer multiple of the number of bits of the second sub preamble.

Yet another exemplary embodiment of the present disclosure provides a digital communication system, including: a preamble generation apparatus including a pseudo noise code generator to generate a first pseudo noise code and a second pseudo noise code that are different from each other, and a line-coder to generate a plurality of same first sub preambles by line-coding the first pseudo noise code, and to generate a second sub preamble behind the plurality of first sub preambles by line-coding the second pseudo noise code; and a preamble detection apparatus to iteratively detect the first sub preamble by performing a correlation value calculation using the first pseudo noise code, and to detect the second sub preamble by performing a correlation value calculation using the second pseudo noise code when the first sub preamble is detected at least a predetermined number of times.

According to the exemplary embodiments of the present disclosure, it is possible to effectively perform frame synchronization while avoiding a low frequency domain having great noise power and minimizing hardware complexity and power consumption by employing a method of generating and detecting a preamble structure in which a sub preamble generated by line-coding a pseudo noise code is repeated in a digital direct transmission system applicable to a human body communication technology.

According to the exemplary embodiment of the present disclosure, it is possible to improve a receiving signal-to-noise ratio (SNR) by obtaining a maximum auto-correlation calculation value corresponding to two folds of the number of bits that a correlation value calculator provided from hardware may calculate at a time according to a line-coding scheme, or by increasing the frequency use efficiency.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating a structure of a preamble according to an exemplary embodiment of the present disclosure.

FIG. 2A is a graph illustrating a frequency property of a preamble when Manchester coding is employed.

FIG. 2B is a graph illustrating a frequency property of a preamble when Miller coding is employed.

FIG. 3 is a flowchart illustrating a method of detecting a preamble according to an exemplary embodiment of the present disclosure.

FIG. 4 is a diagram to describe a method of detecting a first sub preamble and a second sub preamble through a correlation value calculation.

FIG. 5 is a flowchart illustrating a method of detecting a preamble according to another exemplary embodiment of the present disclosure.

FIGS. 6A, 6B, 7A, and 7B are graphs to describe a method of calculating a correlation value when a Manchester code is used.

FIG. 8 is a graph to describe a method of calculating a correlation value when a Miller code is used.

FIG. 9 is a graph illustrating a preamble detection simulation result according to the exemplary embodiments of FIGS. 3 and 5 when Manchester coding is employed.

FIG. 10 is a graph illustrating a preamble detection simulation result when Miller coding is employed.

FIG. 11 is a configuration diagram of a digital communication system applicable to human body communication according to an exemplary embodiment of the present disclosure.

### DETAILED DESCRIPTION

In the following detailed description, reference is made to the accompanying drawing, which form a part hereof. The illustrative embodiments described in the detailed description, drawing, and claims are not meant to be limiting. Other embodiments may be utilized, and other changes may be made, without departing from the spirit or scope of the subject matter presented here. The aforementioned purposes, features, and advantages will be described in detail with reference to the accompanying drawings and thus, the technical spirit of the present disclosure may be easily performed by those skilled in the art. When it is determined the detailed description related to a related known function or configuration may make the purpose of the present disclosure unnecessarily ambiguous in describing the present disclosure, the detailed description will be omitted here. Hereinafter, an exemplary embodiment of the present disclosure will be described in detail with reference to the accompanying drawings.

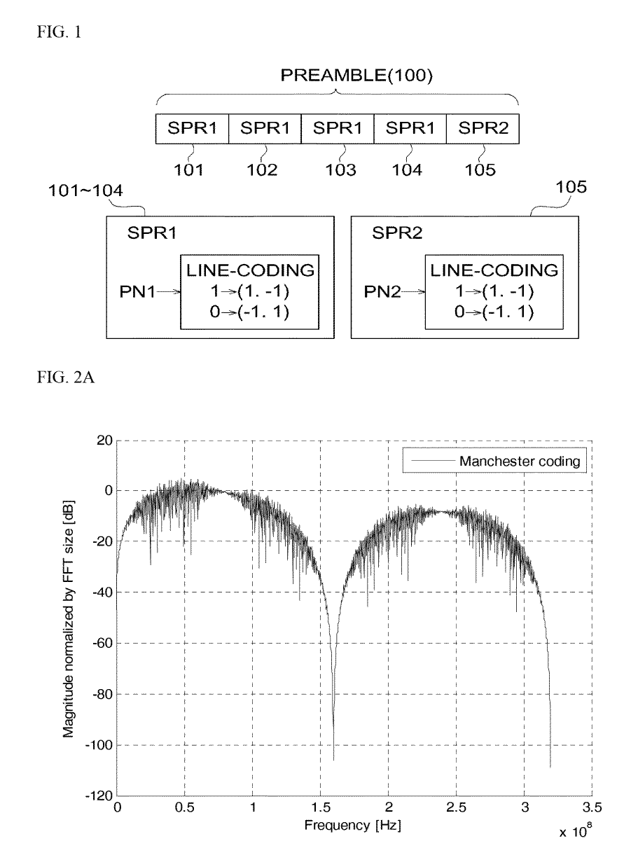

FIG. 1 is a diagram illustrating a structure of a preamble 100 according to an exemplary embodiment of the present disclosure.

Referring to FIG. 1, the preamble 100 includes a plurality of same first sub preambles 101, 102, 103, and 104, and a second sub preamble 105 positioned behind the plurality of same first sub preambles 101, 102, 103, and 104. In the present exemplary embodiment, it is assumed that a total of four same first sub preambles 101, 102, 103, and 104 are present.

The first sub preambles 101, 102, 103, and 104, and the second sub preamble 105 are generated by line-coding a first pseudo noise code PN1 and a second pseudo noise code PN2, respectively, that are different from each other. Here, when a length of the first pseudo noise code PN1 is n, and a length of the second pseudo noise code PN2 is n′, a pseudo noise code PN (not shown) having a length of n+n′ or more may be generated and then, n number of bit values and n′ number of bit values that are continuous without an overlapping portion may be selected and used as the first pseudo noise code PN1 and the second pseudo noise code PN2, respectively. For example, when n=n′=512, a single pseudo noise code PN having the length of 1024 is generated, and indices 1 to 512 may be used as the first pseudo noise code PN1 and indices 513 to 1024 may be used as the second pseudo noise code PN2.

A Manchester coding scheme or a Miller coding scheme may be employed as a line-coding method of the first pseudo noise codes PN1 and the second pseudo noise code PN2. For example, when Manchester coding is employed, a bit value of 1 of the pseudo noise codes PN1 and PN2 may be mapped to (1, −1), and a bit value of 0 may be mapped to (−1, 1).

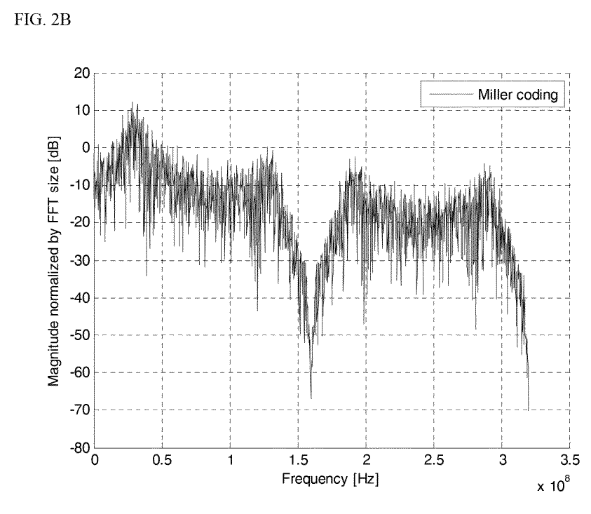

FIG. 2A is a graph illustrating a frequency property of a preamble when Manchester coding is employed, and FIG. 2B is a graph illustrating a frequency property of a preamble when Miller coding is employed. By using a clock frequency of 160 MHz and performing four folds of oversampling, a relative power spectrum density (PSD) characteristic according to frequency was expressed.

As illustrated in FIGS. 2A and 2B, in both a case where Manchester coding is employed and a case where Miller coding is employed, it can be verified that most preamble signals are distributed while avoiding a low frequency band of 5 MHz or less having great noise power in human body communication.

When Miller coding is employed, a frequency band occupied by a preamble signal decreases as compared to a case where Manchester coding is employed. Therefore, it is possible to increase the frequency use efficiency. When Manchester coding is employed, the frequency use efficiency is slightly degraded as compared to Miller coding. However, compared to Miller coding, Manchester coding may decrease hardware complexity when detecting a preamble at a receiver. Hereinafter, a description relating thereto will be described in more detail with reference to a method of detecting a preamble according to the present disclosure.

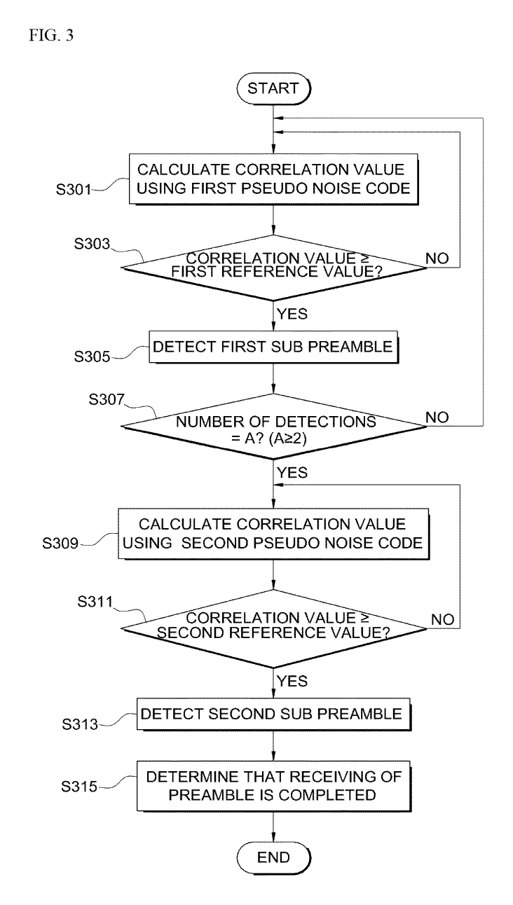

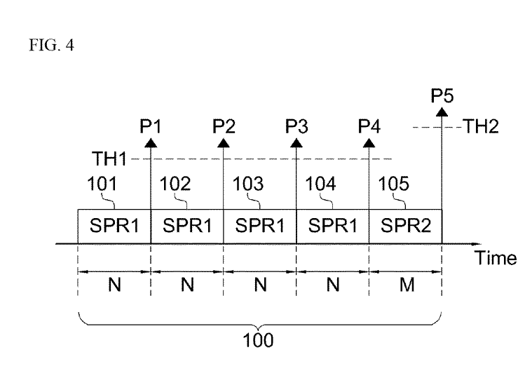

FIG. 3 is a flowchart illustrating a method of detecting a preamble according to an exemplary embodiment of the present disclosure, and FIG. 4 is a diagram to describe a method of detecting a first sub preamble and a second sub preamble through a correlation value calculation. It is assumed that a structure of the preamble 100 is the same as the exemplary embodiment of FIG. 1.

Initially, a correlation value is calculated with respect to a received signal using a first pseudo noise code PN1 (S301).

Next, the calculated correlation value is compared with a predetermined threshold, that is, a first reference value TH1 (S303). When the correlation value is greater than or equal to the first reference value TH1, it is determined that the first sub preambles 101, 102, 103, and 104 are detected (S305). At points where the respective first sub preambles 101, 102, 103, and 104 end, the correlation value has peak values P1, P2, P3, and P4. It is possible to determine that the first sub preambles 101, 102, 103, and 104 are detected at the respective points in times in which the correlation value calculated by setting the first reference value TH1 to be slightly lower than a theoretically calculated maximum correlation value is greater than or equal to the first reference value TH1.

When the number of times that the first sub preambles 101, 102, 103, and 104 are iteratively detected reaches a predetermined number of times (A), it is possible to determine that all the plurality of first sub preambles 101, 102, 103, and 104 included in the preamble 100 are received (S307). Here, the predetermined number of times (A) may be equal to the number of first sub preambles 101, 102, 103, and 104 (A=4 in the present exemplary embodiment), or may be smaller than the number of first sub preamble 101, 102, 103, and 104. Here, A≧2. For example, in a place having a poor channel environment, noise increases in a received signal and thus, the accuracy of a calculated correlation value may be degraded. Therefore, when at least two of the plurality of first sub preambles 101, 102, 103, and 104 are detected for a predetermined period of time, it may be determined that the first sub preambles 101, 102, 103, and 104 are received.

When the number of bits of each of the first sub preambles 101, 102, 103, and 104 is N, it is possible to further increase accuracy of sub preamble detection by calculating a distance between the respective positions at which the correlation value has the peak values P1, P2, P3, and P4, and verifying whether the distance is an integer multiple of N.

When receiving of the first sub preambles 101, 102, 103, and 104 is completed, a correlation value is calculated using the second pseudo noise code PN2 for detection of the second sub preamble 105 (S309).

Next, the calculated correlation value is compared with a second threshold TH2 (S311). When the correlation value is greater than or equal to the second reference value TH2, it is determined that the second sub preamble 105 is detected (S313) and it is determined that receiving of the preamble 100 is completed (S315). Similar to a detection process of the first sub preambles 101, 102, 103, and 104, the correlation value has a peak value P5 at a point where the second sub preamble 105 ends. It may be determined that the second sub preamble 105 is detected at a point in time in which the correlation value calculated by setting the second reference value TH2 to be slightly lower than a theoretically calculated maximum correlation value is greater than or equal to the second reference value TH2.

When the number of bits of the second sub preamble 105 is M, it is possible to further increase accuracy of sub preamble detection by verifying whether a distance between a position at which the correlation value has the peak value P5 and a position at which the correlation value has the peak value P4 matches M. When M=N, it is possible to perform a final detection determination by verifying whether a distance between a final detection position of the first sub preambles 101, 102, 103, and 104 and a detection position of the second sub preamble 105 is an integer multiple of M.

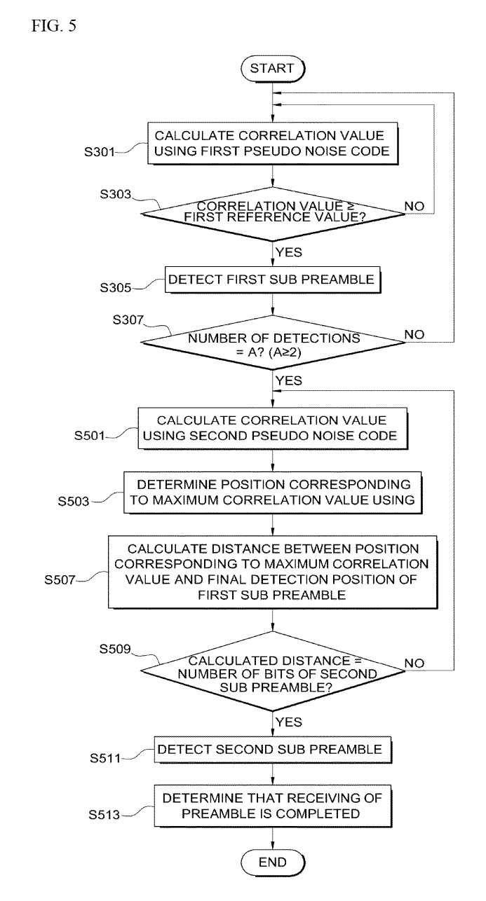

FIG. 5 is a flowchart illustrating a method of detecting a preamble according to another exemplary embodiment of the present disclosure. It is assumed that a structure of the preamble 100 is the same as FIGS. 1 and 4.

In the exemplary embodiment of FIG. 5, a detection process (S301 through S307) of the first sub preambles 101, 102, 103, and 104 is the same as described above with reference to FIG. 3. A difference lies in that maximum likelihood estimation (MLE) is used for detecting the second sub preamble 105 instead of a detection method using a threshold.

When receiving of the first sub preambles 101, 102, 103, and 104 is completed, a correlation value is calculated using the second pseudo noise code PN2 for detection of the second sub preamble 105 (S501).

Next, a position corresponding to a maximum correlation value is determined using the MLE (S503), and a distance between the position and a final detection position of first sub preamble 104 is calculated (S505).

Next, when the calculated distance is equal to the number of bits of the second sub preamble 105 (S509), it is determined that the second sub preamble 105 is detected (S511) and it is determined that receiving of the preamble 100 is completed (S513). When the number of bits of each of the first sub preambles 101, 102, 103, and 104 is equal to the number of bits of the second sub preamble 105, that is, when M=N, it is possible to perform a final detection determination by verifying whether a distance between a final detection position of the first sub preambles 101, 102, 103, and 104 and a detection position of the second sub preamble 105 is an integer multiple of M.

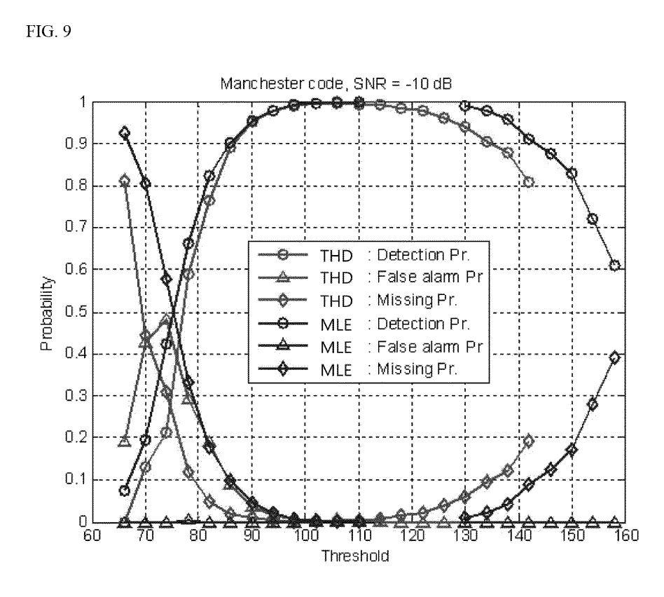

In the method according to the exemplary embodiment of FIG. 5, even though the average number of correlation value calculations increases by employing the MLE as compared to the method of FIG. 3, it is possible to obtain further excellent detection performance (see FIG. 9).

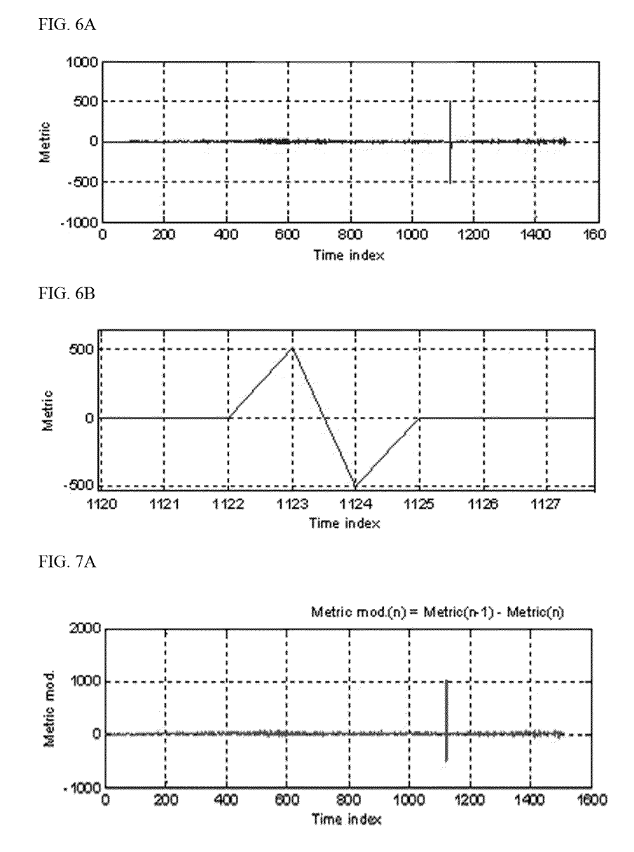

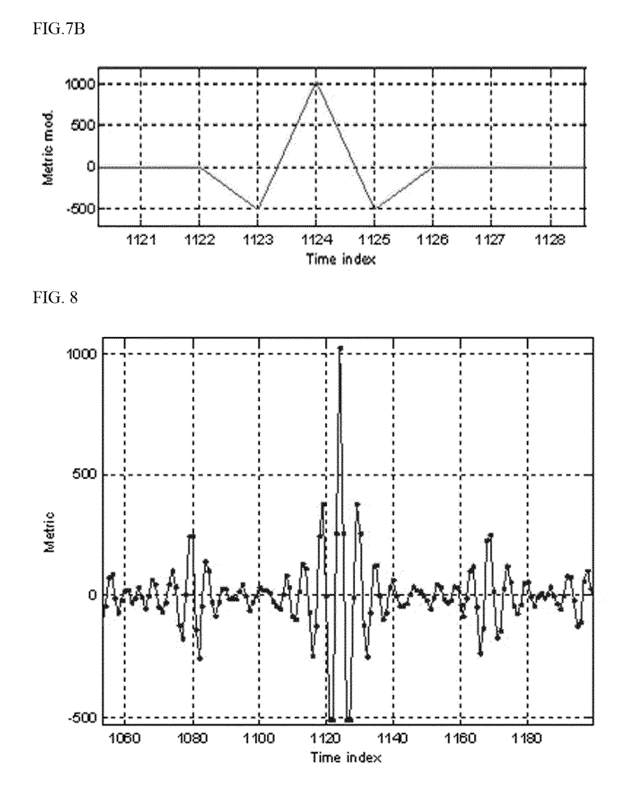

FIGS. 6A, 6B, 7A, and 7B are graphs to describe a method of calculating a correlation value when a Manchester code is used in the above exemplary embodiments.

A correlation value is obtained by sequentially multiplying corresponding bit values of two signals and adding up the multiplication results. For example, when a=[1 −1 1] and b=[−1, −1, −1], a correlation value of a and b becomes (1×−1)+(−1×−1)+(1×−1).

FIG. 6A illustrates a correlation value property of a sub preamble and a pseudo noise code used for generating the sub preamble. A length of the pseudo noise code is 512 and a length of the sub preamble generated by Manchester coding is 1024. An offset is 100. When Manchester coding maps a bit value of 1 to (1 −1) and maps a bit value of 0 to (−1 1) with respect to a predetermined pseudo noise code, all the generated sub preambles have even lengths, and odd-numbered samples of the sub preamble have the same sign value as the pseudo noise code and even-numbered samples of the sub preamble have a sign value different from the pseudo noise code. Accordingly, when a correlation value calculation is performed with respect to the respective odd-numbered and even-numbered samples of the received preamble, and when a length of the sub preamble is N, a positive correlation value is present in an (N−1)-th sample and a negative correlation value is present in an N-th sample. That is, two peak values are present.

Referring to FIG. 6A and FIG. 6B that is an enlarged graph of FIG. 6A, an offset is 100 and thus, it can be verified that metric values 512 and −152 are obtained at time indices 1123 and 1124, respectively.

Here, the entire correlation value detection equation (metric mod) of the sub preamble is determined as follows.

Metric mod(n)=Metric(n−1)−Metric(n) (n: Time index)

Accordingly, a maximum value among the entire correlation values of the sub preamble becomes 1024 that is two folds of a peak value of a correlation value with respect to the respective odd-numbered and even-numbered samples

Referring to FIG. 7A and FIG. 7B that is an enlarged graph of FIG. 7A, an offset is 100 and thus, it can be verified that when n=1024, the entire correlation value (metric mod) has a maximum value of 1024.

On the contrary, when Manchester coding maps a bit value of 1 to (−1 1) and maps a bit value of 0 to (1 −1), signs of the above metric values may become opposite and the detection equation is determined as Metric mod(n)=Metric(n)−Metric(n−1).

Using the above property of Manchester coding, it is possible to decrease hardware complexity on a preamble receiver side. That is, instead of using a 1024-bit calculator to calculate a correlation value with respect to 1024 bits of a sub preamble, by using two 512-bit calculators and obtaining a difference value between calculation results of two calculators, it is possible to obtain the same effect as a case where the 1024-bit calculator is used.

FIG. 8 is a graph to describe a method of calculating a correlation value when a Miller code is used. A length of a pseudo noise code is 512 and a length of the sub preamble generated by Miller coding is 1024. An offset is 100.

Unlike a case where Manchester coding is employed, a receiver calculates a correlation value using a sub preamble. Accordingly, since a 1024-bit calculator needs to be used, a calculation amount increases as compared to Manchester coding. As illustrated in FIG. 8, even though a maximum correlation value can be obtained at a point in time (time index 1124) when the sub preamble ends, a plurality of small peak values is present around due to a property of a Miller code and thus, detection performance may be degraded. However, due to a frequency property as illustrated in FIG. 2B, it is possible to achieve the high frequency use efficiency as compared to Manchester coding. By employing a receiving filter with a narrow bandwidth, a signal-to-noise ratio (SNR) value securable at the receiver may increase.

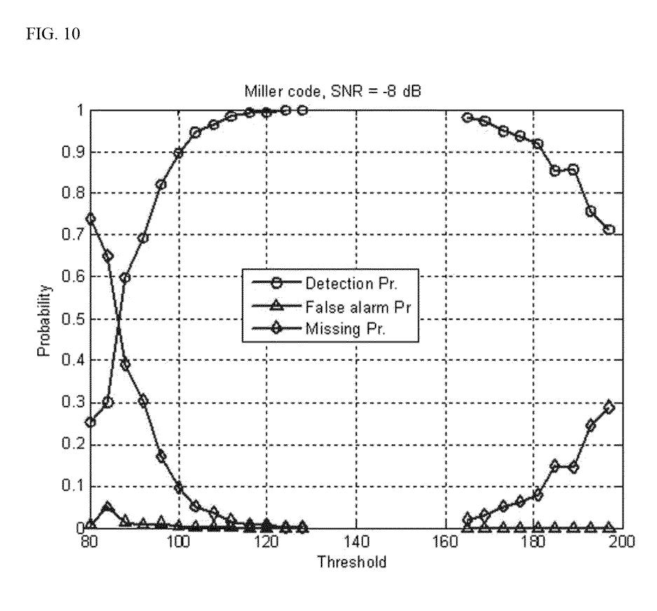

FIG. 9 is a graph illustrating a preamble detection simulation result according to the exemplary embodiments of FIGS. 3 and 5 when Manchester coding is employed, and FIG. 10 is a graph illustrating a preamble detection simulation result when Miller coding is employed.

A total number of sub preambles is four (three first sub preambles and a single second sub preamble), the number of bits of each of the sub preambles is 256 (N=M=256), and the required number of detections of the first sub preambles is twice (A=2).

Referring to FIG. 9, it can be verified that in a Gaussian channel environment in which a receiving SNR is about −10 dB when Manchester coding is employed, a detection method (THD) according to the exemplary embodiment of FIG. 3 has detected a preamble at a probability of about 0.996 or more and a detection method (MLE) according to the exemplary embodiment of FIG. 5 has detected a preamble at a probability of about 0.999 or more. By effectively employing a structure in which the first sub preamble is iteratively used, it is possible to minimize the occurrence probability of false alarm that suspends a detection process in a state in which the receiver has not detected a frame start.

Referring to FIG. 10, it can be verified that in a Gaussian channel environment in which a receiving SNR is about −8 dB when Miller coding is employed, a preamble has been detected at a probability of about 0.999 or more.

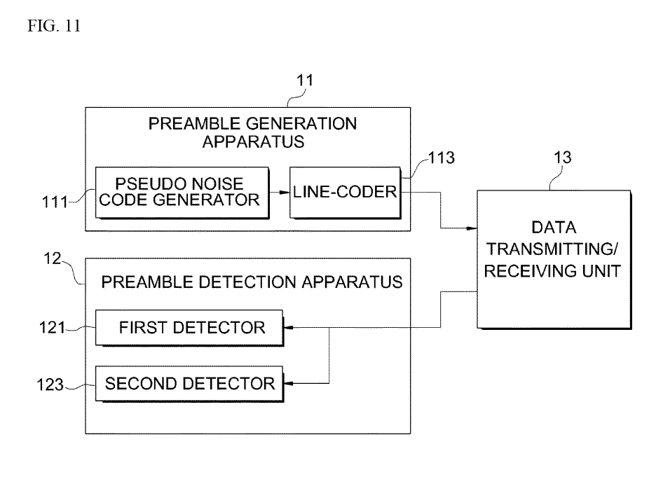

FIG. 11 is a configuration diagram of a digital communication system applicable to human body communication according to an exemplary embodiment of the present disclosure.

Referring to FIG. 11, the digital communication system according to an exemplary embodiment of the present disclosure includes a preamble generation apparatus 11 including a pseudo noise code generator 111 to generate a first pseudo noise code and a second pseudo noise code that are different from each other, and a line-coder 113 to generate a plurality of same first sub preambles by line-coding the first pseudo noise code, and to generate a second sub preamble behind the plurality of first sub preambles by line-coding the second pseudo noise code, and a preamble detection apparatus 12 to iteratively detect the first sub preamble by performing a correlation value calculation using the first pseudo noise code, and to detect the second sub preamble by performing a correlation value calculation using the second pseudo noise code when the first sub preamble is detected at least a predetermined number of times. The digital communication system may further include a data transmitting/receiving unit 113 connected to the preamble generation apparatus 11 and the preamble detection apparatus 12 to transmit/receive a data frame.

When a length of the first pseudo noise code is n, and a length of the second pseudo noise code is n′, the pseudo noise code generator 111 may generate a pseudo noise code having a length of n+n′ or more, and then select n number of bit values and n′ number of bit values that are continuous without an overlapping portion, and use the same as the first pseudo noise code and the second pseudo noise code, respectively. For example, when n=n′=512, the pseudo noise code generator 111 may generate a single pseudo noise code having the length of 1024, and may use indices 1 to 512 as the first pseudo noise code and use indices 513 to 1024 as the second pseudo noise code.

The line-coder 113 may employ a Manchester coding scheme or a Miller coding scheme for line-coding of the first pseudo noise code and the second pseudo noise code.

When the line-coder 113 employs the Manchester coding scheme, the preamble detection apparatus 12 may include a first detector 121 to calculate a correlation value of odd-numbered bit values and a second detector 123 to calculate a correlation value of even-numbered bit values, among received N bits when the number of bits of the first sub preamble is N. For example, when the sub preamble includes 1024 bits, it is possible to configure the first detector 121 and the second detector 123 as correlation value calculators, each having a length of 512 bits. Through this, it is possible to decrease hardware complexity.

When the number of bits of the first sub preamble is N, and when the first sub preamble is detected at least twice and a distance between the respective detected positions is an integer multiple of N, the preamble detection apparatus 12 may be configured to initiate detection of the second sub preamble.

When the number of bits of the second sub preamble is M, the preamble detection apparatus 12 may calculate a correlation value of odd-numbered bit values and a correlation value of even-numbered bit values among received M bits, and may determine that the second sub preamble is received when the difference value between the calculated two correlation values is greater than or equal to a second reference value. Alternatively, the preamble detection apparatus 12 may determine a position corresponding to a maximum correlation value using MLE for detection of the second sub preamble, and may determine that the second sub preamble is detected when a distance between the position corresponding to the maximum correlation value and a final detection position of the first sub preamble is an integer multiple of the number of bits of the second sub preamble.

A more specific preamble generation and detection operation of a digital communication system according to the exemplary embodiment of FIG. 11 and the effects thereof are the same as described above with reference to FIGS. 1 through 10.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims

What is claimed is:

1. A method of generating a preamble, comprising:
generating a first pseudo noise code and a second pseudo noise code that are different from each other;
generating a plurality of same first sub preambles by line-coding the first pseudo noise code; and
generating a second sub preamble behind the plurality of first sub preambles by line-coding the second pseudo noise code.

2. The method of claim 1, wherein a Manchester coding scheme or a Miller coding scheme is employed for line-coding of the first pseudo noise code and the second pseudo noise code.

3. The method of claim 1, wherein the number of bits of each of the first pseudo noise code and the second pseudo noise code is 512, and the number of bits of each of the first sub preamble and the second sub preamble is 1024.

4. The method of claim 1, wherein a generated preamble is used for a communication system of a digital direct transmission scheme to be applied to human body communication.

5. A method of detecting a preamble including a plurality of same first sub preambles and a second sub preamble positioned behind the plurality of first sub preambles, the method comprising:
iteratively detecting the first sub preamble by performing a correlation value calculation using a first pseudo noise code;
detecting the second sub preamble by performing a correlation value calculation using a second pseudo noise code when the first sub preamble is detected at least a predetermined number of times; and
determining that the preamble is received when the second sub preamble is detected,
wherein the first sub preamble and the second sub preamble are generated by line-coding the first pseudo noise code and the second pseudo noise code, respectively.

6. The method of claim 5, wherein the first sub preamble and the second sub preamble are line-coded by employing a Manchester coding scheme.

7. The method of claim 6, wherein the detecting of the first sub preamble comprises:
obtaining a correlation value of odd-numbered bit values and a correlation value of even-numbered bit values among received N bits, and calculating a difference value between the calculated two correlation values when the number of bits of the first sub preamble is N; and
determining that the first sub preamble is detected when the difference value is greater than or equal to a first reference value.

8. The method of claim 6, wherein when the number of bits of the first sub preamble is N, and when the first sub preamble is detected at least twice and a distance between the respective detection positions is an integer multiple of N, the detecting of the second sub preamble is initiated.

9. The method of claim 6, wherein the detecting of the second sub preamble comprises:
obtaining a correlation value of odd-numbered bit values and a correlation value of even-numbered bit values among received M bits, and calculating a difference value between the calculated two correlation values when the number of bits of the second sub preamble is M; and
determining that the second sub preamble is received when the difference value is greater than or equal to a second reference value.

10. The method of claim 6, wherein the detecting of the second sub preamble comprises:
determining a position corresponding to a maximum correlation value using a maximum likelihood estimation; and
determining that the second sub preamble is detected when a distance between the position corresponding to the maximum correlation value and a final detection position of the first sub preamble is an integer multiple of the number of bits of the second sub preamble.

11. The method of claim 5, wherein the number of bits of each of the first pseudo noise code and the second pseudo noise code is 512, and the number of bits of each of the first sub preamble and the second sub preamble is 1024.

12. The method of claim 5, wherein the method of detecting the preamble is used for a communication system of a digital direct transmission scheme to be applied to human body communication.

13. A digital communication system, comprising:
a preamble generation apparatus comprising a pseudo noise code generator to generate a first pseudo noise code and a second pseudo noise code that are different from each other, and a line-coder to generate a plurality of same first sub preambles by line-coding the first pseudo noise code, and to generate a second sub preamble behind the plurality of first sub preambles by line-coding the second pseudo noise code; and
a preamble detection apparatus to iteratively detect the first sub preamble by performing a correlation value calculation using the first pseudo noise code, and to detect the second sub preamble by performing a correlation value calculation using the second pseudo noise code when the first sub preamble is detected at least a predetermined number of times.

14. The digital communication system of claim 13, wherein the line-coder employs a Miller coding scheme for line-coding of the first pseudo noise code and the second pseudo noise code.

15. The digital communication system of claim 13, wherein the line-coder employs a Manchester coding scheme for line-coding of the first pseudo noise code and the second pseudo noise code.

16. The digital communication system of claim 15, wherein the preamble detection apparatus comprises a first detector to calculate a correlation value of odd-numbered bit values and a second detector to calculate a correlation value of even-numbered bit values, among received N bits when the number of bits of the first sub preamble is N, and determines that the first sub preamble is detected when the difference value between the calculated two correlation values is greater than or equal to a first reference value.

17. The digital communication system of claim 15, wherein when the number of bits of the first sub preamble is N, and when the first sub preamble is detected at least twice and a distance between the respective detection positions is an integer multiple of N, the preamble detection apparatus initiates detection of the second sub preamble.

18. The digital communication system of claim 15, wherein when the number of bits of the second sub preamble is M, the preamble detection apparatus calculates a correlation value of odd-numbered bit values and a correlation value of even-numbered bit values among received M bits, and determines that the second sub preamble is received when a difference value between the calculated two correlation values is greater than or equal to a second reference value.

19. The digital communication system of claim 15, wherein the preamble detection apparatus determines a position corresponding to a maximum correlation value using a maximum likelihood estimation for detection of the second sub preamble, and determines that the second sub preamble is detected when a distance between the position corresponding to the maximum correlation value and a final detection position of the first sub preamble is an integer multiple of the number of bits of the second sub preamble.
